(19) United States
(12) Patent Application Publication
(10) Pub. No.: US 2024/0392198 A1
(43) Pub. Date: Nov. 28, 2024

(54) CATALYTIC CRACKING REACTOR, SYSTEM AND APPLICATION

(71) Applicants: CHINA PETROLEUM & CHEMICAL CORPORATION, Beijing (CN); SINOPEC RESEARCH INSTITUTE OF PETROLEUM PROCESSING CO., LTD., Beijing (CN)

(72) Inventors: Xiaoli WEI, Beijing (CN); Zhigang ZHANG, Beijing (CN); Jianhong GONG, Beijing (CN)

(21) Appl. No.: 18/714,805

(22) PCT Filed: Dec. 2, 2022
(86) PCT No.: PCT/CN2022/136055

§ 371 Date: May 30, 2024

(30) Foreign Application Priority Data
Dec. 3, 2021 (CN) 202111466481.1

(51) Int. Cl. C10G 11/18

(52) U.S. Cl. CPC C10G 11/187; C10G 11/182; C10G 2300/1037; C10G 2300/70

(57) ABSTRACT

Disclosed are a fluidized catalytic cracking reactor, a system and an application thereof. The fluidized catalytic cracking reactor comprises sequentially from bottom to top: a catalytic cracking reaction zone and an outlet zone, wherein the top end of the reaction zone is communicated with the bottom end of the outlet zone, wherein the reaction zone comprises at least one diameter contracting reaction section which has inner diameter continuously reduced from its bottom end to its top end, and has inner diameter at the top end which is greater than or equal to that of the outlet zone, and wherein the ratio of the total height of the at least one diameter contracting reaction section to the total height of the reactor is 0.15:1 to 0.8:1.

### TECHNICAL FIELD

The present disclosure relates to the field of petrochemicals. In particular, the present disclosure relates to a fluidized catalytic cracking reactor, a catalytic cracking system comprising the same, and their application.

### BACKGROUND

Ethylene and propylene are the most basic raw materials in the petrochemical industry and the foundation for producing various important organic chemicals. The production scale, output and technological level for producing ethylene and propylene are important indicators for measuring the development level of the petrochemical industry of a country. Although the production capacity and output for ethylene of China have been the second in the world, and those for propylene have been the first in the world, they still cannot meet the demands associated with the national economic development and the improvement on living standards of Chinese. In 2020, the equivalent demands for ethylene and propylene in China are 58.63 million tons and 47.5 million tons, respectively. Basing on the equivalent demands, the self-sufficiency rates for ethylene and propylene are about 51.4% and 79.9%, respectively. Therefore, the production of olefins is still insufficient to meet the demands. Currently, steam cracking of light hydrocarbons such as naphtha remains the main technology for producing ethylene and propylene. In order to achieve the required temperature for cracking, the cracking furnace may use fossil fuels to heat the furnace tubes. It makes the steam cracking furnace be a main source of carbon dioxide emissions and have high energy consumption, and makes the product have poor selectivity, with a large amount of methane formed in the product. Therefore, researchers continuously develop technologies for catalytic cracking of light hydrocarbons such as naphtha to produce olefins.

Chinese patent application CN106221786A discloses a method for converting naphtha. Catalytic cracking of naphtha is combined with steam cracking of low carbon alkanes and catalytic cracking of high carbon alkanes and high carbon olefins, to obtain low carbon olefins, light aromatic hydrocarbons and high-octane gasoline. Most reactants are converted during the catalytic cracking at relatively low temperature. Accordingly, energy consumption can be reduced on the whole.

Chinese patent application CN111484386A discloses a device for converting a naphtha-containing feedstock. The conversion process involves treating the naphtha-containing feedstock in a fast fluidized bed reactor to produce a product gas and a catalyst that needs to be regenerated. Subsequently, a portion of the catalyst that needs to be regenerated is sent back to the fast fluidized bed reactor after steam stripping, while another portion is directed to a regenerator. The technical problem solved by the device is to reduce the impact of a thermal cracking reaction on naphtha catalytic cracking and reduce yield of methane in the product.

Chinese patent application CN109280561A discloses a process for preparing propene and co-producing aromatic hydrocarbons by a low-temperature catalytic reaction using naphtha or light hydrocarbons as feedstocks. The feedstocks, naphtha or light hydrocarbons, are subjected to heat exchanging over a heat exchanger and/or heating by a heater, then are sent into a fixed bed reactor to undergo a low-temperature catalytic reaction in the presence of a specific catalyst, wherein the reaction products are passed through a separation system to obtain aromatic hydrocarbons such as ethylene, propene, C4-5 hydrocarbons and byproducts, toluene and xylene, and the like, wherein a part of the C4-5 hydrocarbons are recycled to the reactor.

Chinese patent application CN111715152A discloses a combined reactor for preparing olefins by dehydrogenation of alkanes and catalytic cracking of hydrocarbons, wherein the reaction device for preparing olefins by catalytic dehydrogenation-cracking of alkanes comprises a reactor for catalytic dehydrogenation-cracking and a disengager section. The disengager section is located over the reactor. The reactor comprises a dehydrogenation reaction section and a cracking reaction section, wherein the dehydrogenation reaction section is located under the cracking reaction section, and one end of a regenerated catalyst standpipe is connected with the dehydrogenation reaction section. The related method is beneficial to both dehydrogenation reaction and catalytic cracking reaction.

As compared with steam cracking, the fixed bed catalytic cracking of naphtha is characterized by lower reaction temperature. However, it may have lower conversion rate for low-carbon alkanes. By combining the catalytic cracking with the steam cracking of naphtha, it is possible to improve the yield of ethylene to a certain degree. However, it may suffer from the problem of carbon emissions. To combine with the dehydrogenation of alkanes may be a promising technological path. However, the mechanism for combining dehydrogenation and cracking in terms of catalysts and process technologies is still being explored.

Light feedstock such as naphtha have small molecules and high reaction activation energy. They may require higher reaction temperature, often result in high yield of by-product methane. The catalytic cracking reaction may involve positive enthalpy change and require a large amount of heat. The coke produced from the cracking process often cannot meet the heat balance requirements of the reaction-regeneration system. The catalytic cracking reaction of light hydrocarbons such as naphtha forms less coke and thereby requires a large amount of additional fuel oils. Due to the fact that molecular sieves are used as active components of the catalyst in the catalytic cracking, the hot-spot by the combustion of fuel oils in the regenerator may gradually destroy the framework aluminum from the molecular sieves. It may lead to a gradual decrease in catalyst activity, which in turn results in further reduction in conversion rate. Therefore, there is a continuous demand for improving and developing technologies for catalytic cracking light feedstocks such as naphtha, so as to obtain higher reaction conversion rates and selectivity. The above-mentioned existing technologies propose methods and catalysts for converting petroleum hydrocarbons feedstocks into light olefins through catalytic cracking reactions. However, they fail to solve the problems of insufficient reaction heat and high yield for methane during the cracking of the light feedstocks.

### SUMMARY OF INVENTION

The present disclosure aims to provide a fluidized catalytic cracking reactor, system and method that can improve the reaction selectivity in catalytic cracking of light feedstocks to produce ethylene and propylene, and reduce the yield of methane.

In order to achieve the above aims, in one aspect, provided in the present disclosure is a fluidized catalytic cracking reactor, comprising sequentially from bottom to top: a catalytic cracking reaction zone and an outlet zone, wherein the top end of the reaction zone is communicated with the bottom end of the outlet zone, wherein the reaction zone comprises at least one diameter contracting reaction section, which has an inner diameter continuously reduced from its bottom end to its top end, and has an inner diameter at the top end which is greater than or equal to that of the outlet zone, and wherein the ratio of the total height of the at least one diameter contracting reaction section to the total height of the reactor is 0.15:1 to 0.8:1.

Preferably, the ratio of the total height of the at least one diameter contracting reaction section to the total height of the reaction zone is 0.7:1 to 0.95:1.

Preferably, a catalyst distributor is provided at the bottom of the at least one diameter contracting reaction section.

Preferably, at least one inlet for additional materials is provided at the upper part of the reaction zone, wherein the distance between the at least one inlet for additional materials and the top end of the reaction zone is independently 0 to 20% of the total height of the reaction zone.

In another aspect, provided in the present disclosure is a catalytic cracking system, comprising a catalytic cracking reaction device, a catalyst separation device, a stripping device, optionally a reaction product separation device and a regenerator, wherein the catalytic cracking reaction device comprises at least one fluidized catalytic cracking reactor in accordance with the present disclosure.

Preferably, at least one inlet for fuel oils is provided at the lower part of the stripping device and/or in the connecting pipeline communicating the stripping device with the regenerator.

In a further aspect, provided in the present disclosure is a catalytic cracking method, comprising the step of subjecting a hydrocarbon containing feedstock and a catalytic cracking catalyst to contacting and reacting in the fluidized catalytic cracking reactor in accordance with the present disclosure or in the fluidized catalytic cracking reactor of the catalytic cracking system in accordance with the present disclosure.

In the fluidized catalytic cracking reactor in accordance with the present disclosure, the diameter contracting reaction section provided has large bottom space, resulting in lower average linear velocity of fluids. It can effectively increase catalyst density therein, thereby significantly increasing the ratio of catalysts to feedstocks. It may strengthen the primary cracking reaction of feedstocks, not only improving the reaction conversion rate, but also increasing yields for low-carbon olefins. Moreover, the diameter contracting structure of the diameter contracting reaction section is advantageous for accelerating the departure of reaction oil and gas from the reaction zone, shortening the reaction time. At the same time, it reduces catalyst backmixing, which is advantageous for reducing the secondary conversion reaction of low-carbon olefins generated in the primary reaction, improving the selectivity for low-carbon olefins.

In the fluidized catalytic cracking reactor in accordance with the present disclosure, preferably, a catalyst distributor is provided at the bottom of the diameter contracting reaction section. The combination of the distributor and the special structure of the diameter contracting reaction section helps to improve the turbulence level of the catalysts in contact with the reactor vapors in the diameter contracting reaction section. It may enhance the adsorption-desorption frequency of feedstock molecules at the active center of the catalysts, weaken the electrostatic effect on the surface of the catalysts, improve the surface diffusion performance of the catalysts, and increase product selectivity.

In the fluidized catalytic cracking reactor in accordance with the present disclosure, a reaction guiding agent may be injected into the upper part of the catalytic cracking reaction zone. It can effectively improve the temperature distribution inside the reactor, and thereby change the course of the cracking reaction, leading to the technical effect of reducing methane. In addition, when petroleum fractions are used as the reaction guiding agent, they may also play a role in supplying fuel oils, helping to improve heat balance.

In the catalytic cracking system in accordance with the present disclosure, fuel oils may be injected into the lower part of the stripper, so as to form additional coke on the catalysts from the fuel oils. After entering the regenerator, the coke may be uniformly distributed within the catalyst bed, and stably and uniformly burn and release heat under the action of oxygen-containing gas. It may lead to synergistic control of distributing fuel oils and burning coke on the catalysts, which may avoid local hotspots and thereby effectively protect the performance of the catalysts.

By using the fluidized catalytic cracking reactor and system in accordance with the present disclosure, it is possible to efficiently produce chemical raw materials such as ethylene and propylene from light petroleum hydrocarbons, assisting the transformation, development and extension of refineries from refining to chemical raw material production. It not only solves the problem of petrochemical raw material shortage, but also improves the economic benefits of refineries. When the reactor and system in accordance with the present disclosure are used for catalytic cracking reactions, achieved are high contact efficiency between the feedstock and the catalysts, good catalytic reaction selectivity, high yield for high value-added products such as ethylene and propylene, and low yield for by-products such as methane.

### BRIEF DESCRIPTION OF THE DRAWINGS

The accompanying drawings are included to provide a further understanding of the invention and are a part of this specification, which, together with the following detailed description, illustrate the invention but not to limit the scope thereof. In the drawings,

FIG. 1A schematically shows a preferred embodiment of the fluidized catalytic cracking reactor in accordance with the present disclosure;

FIG. 1B schematically shows another preferred embodiment of the fluidized catalytic cracking reactor in accordance with the present disclosure;

FIG. 2 schematically shows a further preferred embodiment of the fluidized catalytic cracking reactor in accordance with the present disclosure;

FIG. 3 schematically shows a catalytic cracking system in accordance with an embodiment of the present disclosure; and

FIG. 4 schematically shows a catalytic cracking system in accordance with another embodiment of the present disclosure.

### DETAILED DESCRIPTION

The present disclosure will be described in detail below based on the accompanying drawings and embodiments. The features and advantages of the present invention will become more apparent through the detailed description.

The expression “illustrative” or “exemplary” specially used herein means “used as an example, embodiment, or illustration”. Any “illustrative” or “exemplary” embodiments described herein shall not be interpreted as being better than or superior to other embodiments. Although various aspects of the embodiments are shown in the accompanying drawings, the drawings are not necessarily to scale, unless otherwise indicated.

It should be understood that any values (including the endpoints in ranges of values) disclosed herein are not limited to the precise values, but to encompass values close to those precise values, for example, all possible values within +5% of those precise values. For ranges of values disclosed herein, it is possible to combine between the endpoints of each of the ranges, between the endpoints of each of the ranges and the individual points, and between the individual points to give one or more new ranges of values as if these ranges of values are specifically disclosed herein.

The expressions “upstream” and “downstream” used herein are both based on the moving direction of reaction streams. For example, when the reaction streams flow from bottom to top, “upstream” represents a lower position and “downstream” represents an upper position.

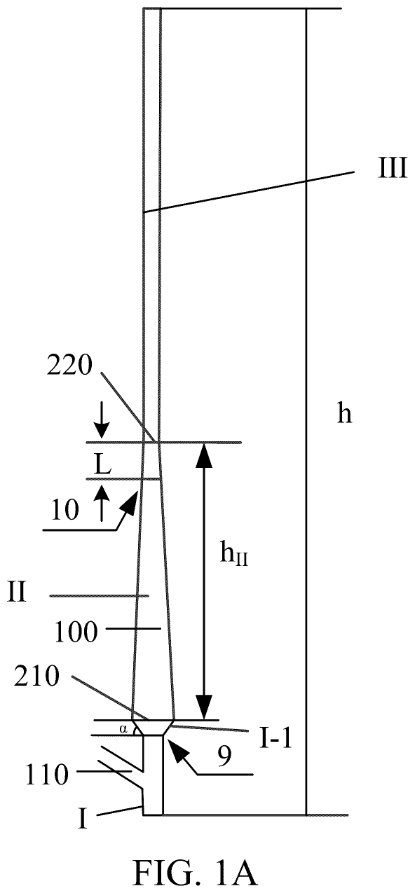

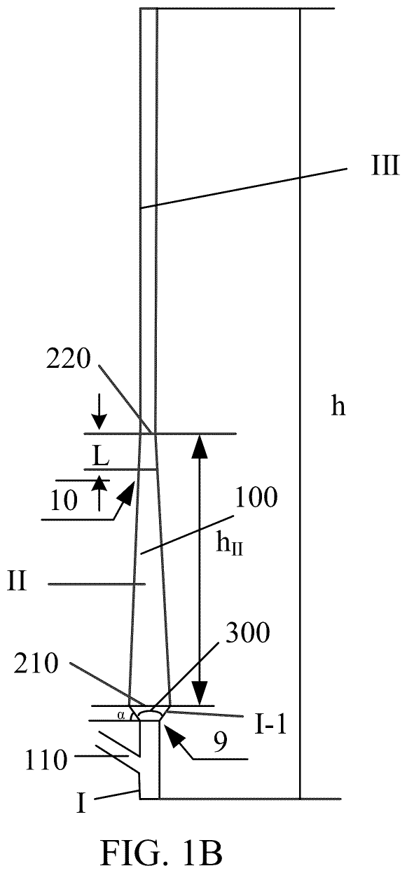

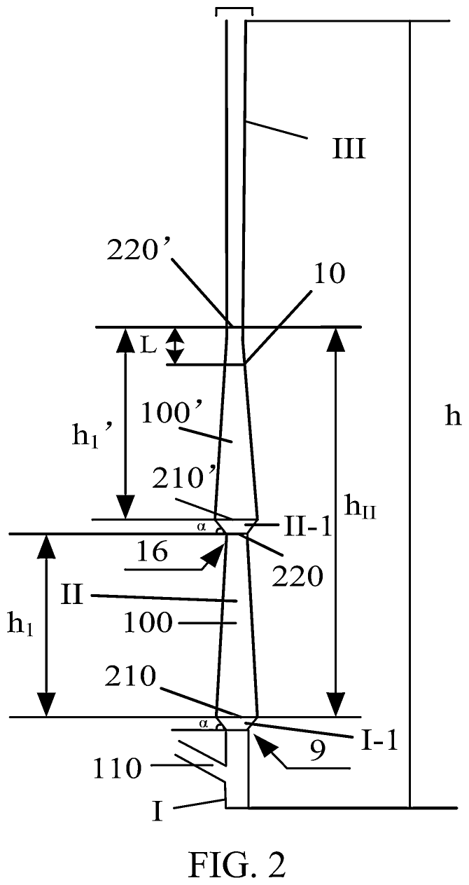

The expression “an outward inclination angle of the side of an isosceles trapezoid a” used herein refers to the angle that complements the lower corner of the isosceles trapezoid, as shown in FIGS. 1A, 1B and 2.

Unless otherwise stated, the terms used herein have the same meaning as commonly understood by the person skilled in the art; and if the terms are defined herein and their definitions are different from the ordinary understanding in the art, the definition provided herein shall prevail.

In addition, it is possible to combine technical features involved in different embodiments in accordance with the present disclosure described below as long as they do not conflict with each other.

As mentioned above, in the first aspect, provided in the present disclosure is a fluidized catalytic cracking reactor, comprising sequentially from bottom to top: a catalytic cracking reaction zone and an outlet zone, wherein the top end of the reaction zone is communicated with the bottom end of the outlet zone, wherein the reaction zone comprises at least one diameter contracting reaction section which has an inner diameter continuously reduced from its bottom end to its top end and has an inner diameter at the top end which is greater than or equal to inner diameter of the outlet zone.

In the fluidized catalytic cracking reactor in accordance with the present disclosure, the catalytic cracking reaction zone is a fluidized bed, preferably selected from a group consisting of a dilute-phase transport fluidized bed, a turbulent fluidized bed, a fast fluidized bed, and a combination thereof.

In accordance with the present disclosure, the at least one diameter contracting reaction section constitutes the main part of the catalytic cracking reaction zone. For example, the reaction zone may be consisting of the at least one diameter contracting reaction section, optionally a connecting section which connects adjacent diameter contracting reaction sections, and optionally a transition section which connects the reaction zone with other parts of the reactor (such as the outlet zone, a catalyst lift zone, and the like). In embodiments, the ratio of the total height of the at least one diameter contracting reaction section to the total height of the catalytic cracking reaction zone is 0.70:1 to 0.95:1, for example, 0.75:1 to 0.9:1.

In an embodiment in accordance with the present disclosure, the diameter contracting reaction section is a hollow column having a roughly circular cross-section and openings at the bottom and top ends, wherein its inner diameter is continuously reduced from its bottom end to its top end. Specifically, the inner diameter of the diameter contracting reaction section may be continuously reduced in a linear or nonlinear manner. Examples of a diameter contracting reaction section with a linear reduced inner diameter may cover a reaction section in the form of a hollow truncated cone. Preferably, the reaction zone is a cylinder consisting of at least one segment, preferably 1-3 segments, of the hollow truncated cone, optionally a connecting section which connects adjacent segments of the hollow truncated cone, and optionally a transition section which connects the reaction zone with other parts of the reactor.

Without being bound by any specific theory, it is believed that, in the fluidized catalytic cracking reactor in accordance with the present disclosure, the diameter contracting reaction section (e.g. the reaction section of the hollow truncated cone) has large bottom space, resulting in lower average linear velocity of fluids. It can effectively increase the catalyst density therein, thereby significantly increasing the ratio of catalysts to feedstocks. In addition, the bottom space is in the turbulent or rapid fluidization operation zone, in which the violent merging and breaking of bubbles leads to intensified mixing and backmixing of particles, increasing the degree of turbulence. Accordingly, it may enhance gas-solid contact efficiency, improve mass and heat transfer, and strengthen the primary cracking reaction of feedstocks. It may not only improve the reaction conversion rate, but also increase the yield for low-carbon olefins. Moreover, the diameter contracting structure of the diameter contracting reaction section is advantageous for accelerating the departure of reactor vapors from the reaction zone, shortening the reaction time. At the same time, it may change the moving direction of gas and solid phases. At the bottom of the diameter contracting reaction section, the streams having a certain initial velocity may aggregate towards the center due to the acceleration effect of the diameter contracting structure. Accordingly, the core-annulus structure in a traditional riser is destroyed. It may reduce catalyst backmixing, which is advantageous for reducing the secondary conversion reaction of low-carbon olefins generated in the primary reaction, and improving the selectivity for low-carbon olefins.

In a preferred embodiment, a catalyst distributor is provided at the bottom of the at least one diameter contracting reaction section of the fluidized catalytic cracking reactor. Further preferably, when multiple diameter contracting reaction sections are provided, the catalyst distributor is provided at the bottom of the most upstream diameter contracting reaction section along the streams moving direction. More further preferably, the catalyst distributor is provided at the bottom of each diameter contracting reaction section.

In such preferred embodiments, the combination of the distributor provided at the bottom of the diameter contracting reaction section and the special structure of the diameter contracting reaction section helps to improve the turbulence level of the catalyst in contact with the reactor vapors in the diameter contracting reaction section. It may enhance the adsorption desorption frequency of feedstock molecules at the active center of the catalysts, weaken the electrostatic effect on the surface of the catalysts, improve the surface diffusion performance of the catalysts, and increase product selectivity.

The catalyst distributor applicable in the present disclosure may be those commonly used industrial fluid distributors, such as one or more selected from a group consisting of flat, arched, disc-shaped, annular, umbrella shaped and bubble caps distributors, preferably an arched or bubble caps distributor.

In accordance with the present disclosure, a catalyst lift zone is not necessary in the fluidized catalytic cracking reactor. For example, when the reactor in accordance with the present disclosure is used in series with other reactors such as a riser reactor, the catalytic cracking reaction zone may be directly connected to the outlet of other upstream reactors, avoiding the use of the catalyst lift zone. In certain embodiments, the fluidized catalytic cracking reactor in accordance with the present disclosure may not include a catalyst lift zone. For such cases, at least one inlet for catalytic cracking catalysts and/or at least one inlet for feedstocks may be provided in the catalytic cracking reaction zone, such as at the bottom of the reaction zone, so as to facilitate the entry of catalysts and/or feedstocks and the like into the catalytic cracking reaction zone. Certainly, the reaction zone may also be free from inlets for catalysts and feedstocks. Instead, catalysts and feedstocks may be from those carried in other reactor streams. Those embodiments are all within the protection scope of the present disclosure.

In a preferred embodiment, the fluidized catalytic cracking reactor further comprises a catalyst lift zone, wherein the top end of the catalyst lift zone is communicated with the bottom end of the reaction zone, wherein at least one, preferably 1-3, inlet for catalytic cracking catalysts is provided in the catalyst lift zone and/or the reaction zone (such as at the bottom and/or middle of the reaction zone), and at least one, preferably 1-3, inlet for feedstocks is provided in the catalyst lift zone and/or the reaction zone (such as at the bottom and/or middle of the reaction zone), and wherein the inner diameter at the bottom end of the at least one diameter contracting reaction section is greater than that of the catalyst lift zone. Further preferably, the inner diameter at the top end of the at least one diameter contracting reaction section is greater than or equal to that of the catalyst lift zone.

In some preferred embodiments, when n diameter contracting reaction sections are provided, where n≥2, an additional inlet for catalytic cracking catalysts and/or an additional inlet for feedstocks is provided at the bottom of at least one, preferably each one, of the second to n diameter contracting reaction sections along the streams moving direction.

In accordance with the present disclosure, at least one, such as one, two, three or more, inlet for feedstocks may be provided in the fluidized catalytic cracking reactor, wherein the at least one inlet for feedstocks may be independently provided at the top outlet of the catalyst lift zone and/or at the bottom and/or middle of the catalytic cracking reaction zone. In certain embodiments, multiple (such as 2-3) inlets for feedstocks are provided in the fluidized catalytic cracking reactor, wherein the multiple inlets for feedstocks are independently placed at the same or different heights in the catalyst lift zone and/or catalytic cracking reaction zone. For example, one inlet for feedstocks may be placed at the top outlet of the catalyst lift zone, and another inlet for feedstocks may be placed at the connecting section between two diameter contracting reaction sections in the catalytic cracking reaction zone. By this way, it is possible to feed feedstocks with different properties separately through different inlets for feedstocks. For example, C4-C12 hydrocarbon feedstocks may be fed through the inlet for feedstocks in the catalyst lift zone, and C12-C20 hydrocarbon feedstocks may be fed through the inlet for feed at the middle of the reaction zone.

In a preferred embodiment, at least one, preferably 1-3, inlet for additional materials is provided at the upper part of the reaction zone, wherein the distance between the at least one inlet for additional materials and the top end of the reaction zone is independently 0 to 20%, preferably 0 to 15% of the total height of the reaction zone.

In accordance with the present disclosure, a reaction guiding agent may be injected into the upper part of the catalytic cracking reaction zone of the fluidized catalytic cracking reactor through the inlet for additional materials. By this way, it is possible to effectively improve the temperature distribution inside the reactor, and thereby change the course of the cracking reaction, leading to the technical effect of reducing methane. The reaction guiding agent applicable in this disclosure may be selected from a group consisting of water and petroleum fractions, wherein the petroleum fractions are selected from a group consisting of naphtha, middle distillates, gasoil, slurry oil, and a combination thereof. In addition, when petroleum fraction oils are used as the reaction guiding agent, they may also play a role in supplying fuel oils, helping to improve heat balance in the reactor-regenerator system.

In accordance with the present disclosure, C4 and/or C5 fractions produced may also be injected into the upper part of the reaction zone of the fluidized catalytic cracking reactor through the inlet for additional materials. By this way, it is possible to further improve yield and selectivity for low-carbon olefins and to improve the utilization ratio of feedstock.

In a preferred embodiment, the ratio of the total height of the at least one diameter contracting reaction section to the total height of the reactor is 0.15:1 to 0.8:1, such as 0.2:1 to 0.75:1.

In a preferred embodiment, the total height of the catalytic cracking reaction zone is 2-50 meters, preferably 5-40 meters, more preferably 8-20 meters, and the total height of the fluidized catalytic cracking reactor is 40-70 meters.

In a preferred embodiment, the catalytic cracking reaction zone comprises 1-10, preferably 1-5, and more preferably 1-3 diameter contracting reaction sections. When the reaction zone comprises 2, 3 or more diameter contracting reaction sections, each diameter contracting reaction section may have the same or different heights, inner diameters and structures, which are not strictly limited in the disclosure.

In a preferred embodiment, the ratio of inner diameter at the bottom end to inner diameter at the top end of the at least one diameter contracting reaction section is independently greater than 1.2:1 to 10:1, preferably 1.5:1 to 5:1. Further preferably, the ratio of inner diameter at the bottom end of the at least one diameter contracting reaction section to the total height of the reactor is independently 0.01:1 to 0.5:1, preferably 0.05:1 to 0.2:1.

In a preferred embodiment, the at least one diameter contracting reaction section is in the form of a hollow truncated cone with the longitudinal cross section in the shape of an isosceles trapezoid. The ratio of inner diameter at the top end to the height of the at least one diameter contracting reaction section is independently 0.005-0.3:1, preferably 0.02-0.2:1. The ratio of inner diameter at the bottom end to the height of the at least one diameter contracting reaction section is independently 0.015-0.25:1, preferably 0.02-0.2. The ratio of inner diameter at the bottom end to inner diameter at the top end of the at least one diameter contracting reaction section is independently greater than 1.2:1 to 10:1, preferably 1.5:1 to 5:1. Further preferably, the ratio of the height of the at least one diameter contracting reaction section to the total height of the reactor is independently 0.15:1 to 0.8:1, for example, 0.2:1 to 0.75:1. More further preferably, inner diameter at the top end of the at least one diameter contracting reaction section is independently 0.2-5 meters, preferably 0.4-3 meters.

In a preferred embodiment, the ratio of inner diameter to the height of the catalyst lift zone is 0.02-0.4:1, preferably 0.04-0.3. The ratio of the height of the catalyst lift zone to the total height of the reactor is 0.01:1 to 0.2:1, preferably 0.05:1 to 0.15:1. Further preferably, the inner diameter of the catalyst lift zone is 0.2-5 meters, preferably 0.4-3 meters.

In a preferred embodiment, the catalyst lift zone is connected to the catalytic cracking reaction zone through a first transition section. The first transition section is in the form of an inverted hollow truncated cone which has a longitudinal cross section in the shape of an isosceles trapezoid with an outward inclination angle on the side of the isosceles trapezoid a of 5-85°, preferably 15-75°.

In some preferred embodiments, inner diameter at the top of the reaction zone is greater than inner diameter of the outlet zone, and the reaction zone and the outlet zone are connected through a second transition section. Preferably, the second transition section is in the form of a hollow truncated cone which has a longitudinal cross section in the shape of an isosceles trapezoid with an outward inclination angle on the side of the isosceles trapezoid a of 95-175°, preferably 105-165°.

In a preferred embodiment, the ratio of inner diameter to the height of the outlet zone is 0.01-0.3:1, preferably 0.05-0.2. The ratio of the height of the outlet zone to the total height of the reactor is 0.05:1 to 0.5:1, preferably 0.1:1 to 0.35:1. Further preferably, inner diameter of the outlet zone is 0.2-5 meters, preferably 0.4-3 meters.

In accordance with the present disclosure, the outlet end of the outlet zone may be open or directly connected to the inlet of a cyclone separator.

Without being bound by any specific theory, it is believed that, in the fluidized catalytic cracking reactor in accordance with the present disclosure, the outlet zone may generate sufficient velocity field, which counteracts the effect of gravity on particles. It may impart the streams with upward force to offset the influence of wall friction and radial diffusion. Accordingly, the streams may flow in the reactor in a form similar to “plug flow”, which may reduce secondary reactions.

The preferred embodiments of the fluidized catalytic cracking reactor in accordance with the present disclosure will be described in detail below with reference to the accompanying drawings. However, the scope of the present disclosure is not limited to those preferred embodiments.

As shown in FIGS. 1A, 1B and 2, in a preferred embodiment, the fluidized catalytic cracking reactor in accordance with the present disclosure comprises from bottom to top: a catalyst lift zone I, a catalytic cracking reaction zone II and an outlet zone III, wherein the top end of the catalyst lift zone I is communicated with the bottom end of the reaction zone II, and the top end of the reaction zone II is communicated with the bottom end of the outlet zone III. An inlet 110 for catalysts is provided at the lower part of the catalyst lift zone I, wherein the catalysts fed through the inlet 110 is raised and transported by catalyst lift medium to the reaction zone II. The catalyst lift zone I may be in the structure of a hollow cylinder which has a ratio of inner diameter to height of 0.02-0.4:1, a ratio of the height to the total height of the reactor of 0.01:1 to 0.2:1, and an inner diameter of 0.2-5 meters.

The catalyst lift zone I is connected to the reaction zone II through a first transition section I-1, where the first transition section I-1 has a longitudinal cross section of an isosceles trapezoid with an outward inclination angle of the side of the isosceles trapezoid a of 5-85°. An inlet 9 for feedstocks is provided at the upper part of the catalyst lift zone I, in the first transition section I-1 and/or at the lower part of the reaction zone II. In addition, an additional inlet 16 for feedstocks is provided at the middle part of the reaction zone II of the reactor shown in FIG. 2, i.e. at the bottom end of the upper diameter contracting reaction section, for feeding other feedstocks or recycled streams.

The reaction zone II includes at least one diameter contracting reaction section. The diameter contracting reaction section is a hollow column having a roughly circular cross-section and openings at the bottom and top ends, wherein its inner diameter is continuously reduced from its bottom end to its top end. Inner diameter at the bottom end of each diameter contracting reaction section in the reaction zone II is greater than inner diameter of the catalyst lift zone I, and inner diameter at the top end of each diameter contracting reaction section is equal to inner diameter of the catalyst lift zone I and inner diameter of the outlet zone III.

At least one inlet 10 for additional materials is provided at the upper part of the reaction zone II near the top outlet. The at least one inlet 10 for additional materials is independently positioned so that the distance between it and the top end of the reaction zone II is 0 to 20% of the total height of the reaction zone.

In particular, as shown in FIGS. 1A and 1B, in a preferred embodiment, the reaction zone II comprises one diameter contracting reaction section 100, which is in the form of a hollow truncated cone having a longitudinal cross section of an isosceles trapezoid. The diameter contracting reaction section 100 has a ratio of inner diameter D₂₂₀ at the top end to its height (in FIGS. 1A and 1B, the height of the diameter contracting reaction section 100 is equal to the height h_{II} of the reaction zone II) of 0.005-0.3:1, a ratio of inner diameter D₂₁₀ at the bottom end to its height of 0.015-0.25:1, a ratio of inner diameter D₂₁₀ at the bottom end to inner diameter D₂₂₀ at the top end of greater than 1.2:1 to 10:1, a ratio of its height to the total height h of the reactor of 0.15:1 to 0.8:1. As compared with the reactor in FIG. 1A, the reactor in FIG. 1B further comprises a catalyst distributor 300 provided at the bottom of the diameter contracting reaction section 100.

As shown in FIG. 2, in another preferred embodiment, the reaction zone II comprises two diameter contracting reaction sections 100, 100′, connected in series. The two diameter contracting reaction sections are all in the form of a hollow truncated cone having a longitudinal cross section of an isosceles trapezoid. The ratios of inner diameters D₂₂₀ and D₂₂₀′ at the top end to the heights h₁ and h₁′ of the corresponding diameter contracting reaction sections are independently 0.005-0.3:1. The ratios of inner diameters D₂₁₀ and D₂₁₀′ at the bottom end to the heights h₁ and h₁′ of the corresponding diameter contracting reaction sections are independently 0.015-0.25:1. The ratios of inner diameters D₂₁₀ and D₂₁₀′ at the bottom end to inner diameters D₂₂₀ and D₂₂₀′ at the top end are independently greater than 1.2:1 to 10:1. The ratios of the heights h₁ and h₁′ of the diameter contracting reaction sections 100, 100′ to the total height h of the reactor are independently 0.15:1 to 0.8:1. The ratios of inner diameters D₂₁₀ and D₂₁₀′ at the bottom end of the diameter contracting reaction sections 100, 100′ to the total height h of the reactor are independently 0.01:1 to 0.5:1. The ratio of the total height hu of the reaction zone II to the total height h of the reactor is 0.15:1 to 0.8:1. The diameter contracting reaction sections 100, 100′ are connected by a connecting section II-1, which has a longitudinal cross section of an isosceles trapezoid with an outward inclination angle on the side of the isosceles trapezoid a of 5-85°.

As shown in FIGS. 1A, 1B and 2, the outlet zone III of the fluidized catalytic cracking reactor is in the form of a hollow cylinder, wherein the outlet zone III has a ratio of inner diameter to the height h_{III} of 0.01-0.3:1, and wherein the ratio of the height h_{III} of the outlet zone to the total height h of the reactor is 0.05:1 to 0.5:1.

In the second aspect, provided in the present disclosure is a catalytic cracking system, comprising a catalytic cracking reaction device, a catalyst separation device, a stripping device, optionally a reaction product separation device, and a regenerator, wherein the catalytic cracking reaction device comprises at least one, preferably 1-3, fluidized catalytic cracking reactor in accordance with the present disclosure.

In the catalytic cracking system in accordance with the present disclosure, there may be one or more fluidized catalytic cracking reactors, which may be a combination of one fluidized catalytic cracking reactor in accordance with the present disclosure and other existing fluidized catalytic cracking reactors, or a combination of multiple fluidized catalytic cracking reactors in accordance with the present disclosure. Those reactors may be connected in parallel and further connected to the catalyst separation device.

In a preferred embodiment, at least one, preferably 1-3, inlet for fuel oils is provided at the lower part of the stripping device and/or in the connecting pipeline between the stripping device and the regenerator, for providing additional fuel oils to the spent catalysts. By this way, it is possible to form additional coke from the fuel oils on the spent catalysts before the spent catalysts entering the regenerator. After entering the regenerator, the fuel oil is uniformly distributed within the catalyst bed, and may stably and uniformly burn and release heat under the action of oxygen-containing gas. It results in synergistic control of distributing fuel oils and burning coke on the catalysts, which may avoid local hotspots and thereby effectively protect the service performance of the catalysts.

In some preferred embodiments, the at least one, preferably 1-3, inlet for fuel oils is provided at the lower part of the stripping device, and the distance from the at least one inlet for fuel oils to the bottom end of the stripping device is independently 0-30%, preferably 5-25% of the height of the stripping device.

In the catalytic cracking system in accordance with the present disclosure, the stripping device, the catalyst separation device, the regenerator, the reaction product separation device, and the like may be those devices well-known to those skilled in the art. The connection between those devices may be made in a manner known in the art. For example, the catalyst separation device may include a cyclone separator and an outlet rapid separator. In certain embodiments, the catalyst separation device comprises a disengager coaxially arranged with the fluidized catalytic cracking reactor or arranged with it in parallel at high and low positions. The reaction product separation device may be various reactor vapors separation devices commonly used in the art, such as a distillation column. It may be equipped with an outlet for dry gas, an outlet for liquefied gas, an outlet for cracked gasoline, an outlet for cracked diesel and an outlet for cracked heavy oil, for separating components such as dry gas, liquefied gas, cracked gasoline, cracked diesel and cracked heavy oil according to the distillation range of the reaction products.

The preferred embodiments of the catalytic cracking system in accordance with the present disclosure will be described in detail below with reference to the accompanying drawings. However, the scope of the present disclosure is not limited to those preferred embodiments.

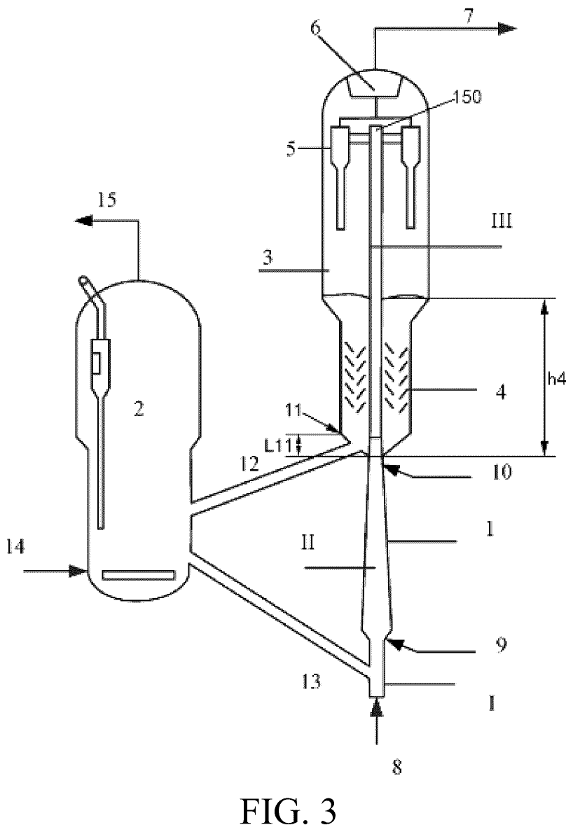

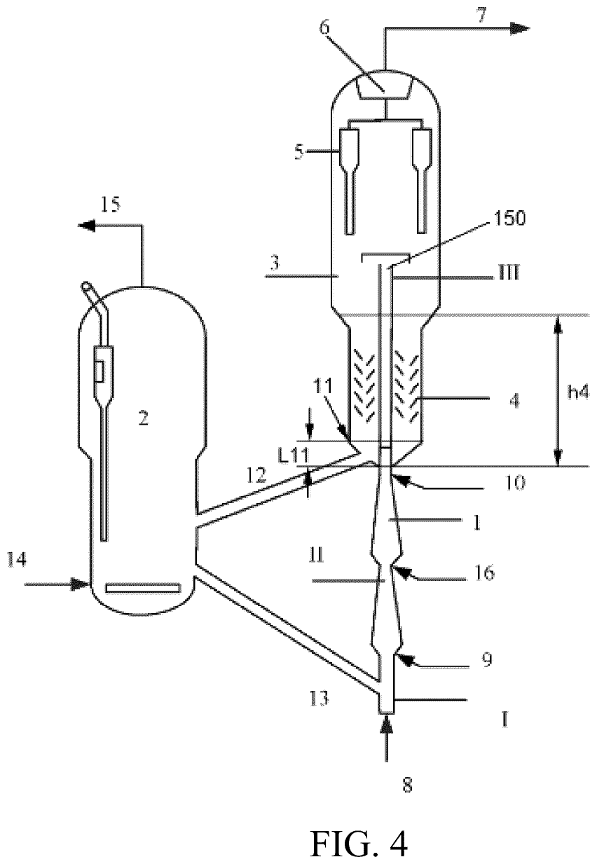

As shown in FIGS. 3 and 4, in a preferred embodiment, the catalytic cracking system in accordance with the present disclosure comprises a fluidized catalytic cracking reactor 1, a catalyst separation device 5, a disengager 3, a stripping device 4 and a regenerator 2, wherein the fluidized catalytic cracking reactor 1 shown in FIG. 3 is the reactor shown in FIG. 1A or 1B, and the fluidized catalytic cracking reactor 1 shown in FIG. 4 is the reactor shown in FIG. 2. An inlet 13 for catalysts is provided in the catalyst lift zone I of the fluidized catalytic cracking reactor 1, and an inlet 9 for feedstocks is provided at the bottom end and an outlet 150 for reactor vapors and catalysts is proved at the top end of the catalytic cracking reaction zone II. For the catalytic cracking reaction zone II shown in FIG. 4, an additional inlet 16 for feedstocks is further provided at the middle of the reaction zone II. The catalyst separation device 5 is used to separate reactor vapors and catalysts from the reaction effluent of the fluidized catalytic cracking reactor 1. The disengager 3 is used to settle the catalysts separated by the catalyst separation device 5 and send them to the stripping device 4. The stripping device 4 is used for stripping catalysts to recover oil vapors. The regenerator 2 is connected to the stripping device 4 through a spent catalyst inclined tube 12, which is used to send the spent catalysts from the stripping device 4 to the regenerator 2 for regeneration. The regenerator 2 is also connected to the catalyst lift zone I of the fluidized catalytic cracking reactor 1 through a regenerated catalyst standpipe 13, which is used to recycle the regenerated catalysts back to the fluidized catalytic cracking reactor 1 for reaction.

The reactor vapors (i.e. reaction products) separated by the separation device 5 is collected in a plenum chamber 6 and transported through a vapor line 7 to the subsequent reaction product separation device (not shown) for separation. In the regenerator 2, the spent catalysts are burned under the action of oxygen-containing gas introduced through a pipeline 14, to obtain regenerated catalysts, which are sent to the reactor 1 through the regenerated catalyst standpipe 13. Flue gas is discharged into an energy recovery system through a pipeline 15.

At least one inlet 11 for fuel oils is provided at the lower part of the stripping device 4, wherein the distance Li between the at least one inlet 11 for fuel oils and the bottom end of the stripping device is independently 0-30% of the height h₄ of the stripping device.

In the third aspect, provided in the present disclosure is a catalytic cracking method, comprising the step of subjecting a hydrocarbon containing feedstock and a catalytic cracking catalyst to contacting and reacting in the fluidized catalytic cracking reactor in accordance with the present disclosure, preferably in the fluidized catalytic cracking reactor of the catalytic cracking system in accordance with the present disclosure.

The fluidized catalytic cracking reactor and system in accordance with the present disclosure are suitable for catalytic cracking reactions of various feedstock, for example, the reactions of catalytic cracking of light hydrocarbons or light fraction oils, oxygen-containing hydrocarbons, shale oils, hydrogenated VGO, hydrocracking gasoil, hydrocracking bottoms, or mixed feedstocks of one or more of the above materials, to produce low-carbon olefins, especially the reactions of catalytic cracking of light hydrocarbons or light fraction oils to produce low-carbon olefins.

For example, the light hydrocarbons or light fraction oils may be gaseous hydrocarbons, petroleum hydrocarbons with a distillation range of 25-350° C., oxygen-containing compounds, fraction oils from biomass or waste plastic generated oils. The gaseous hydrocarbons may be selected from a group consisting of saturated liquefied gas, unsaturated liquefied gas, C4 fractions, and a combination thereof. The petroleum hydrocarbons may be selected from a group consisting of straight run naphtha, straight run kerosene, straight run diesel obtained in once run process or a combination thereof, as well as secondary processed decanted oil, raffinate oil, hydrocracked light naphtha, pentane oil, coking gasoline, Fischer-Tropsch synthetic oil, catalytic cracked light gasoline, hydrogenated gasoline, hydrogenated diesel and a combination thereof. In a preferred embodiment, the feedstock is selected from a group consisting of light feedstock oils of C4-C20.

In a preferred embodiment, the catalytic cracking reaction zone of the fluidized catalytic cracking reactor may be operated at reaction conditions of: a reaction temperature of 510-750° C., a reaction time of 0.5-10 seconds, a weight ratio of catalysts to oils of 10:1 to 50:1, and a weight ratio of water to oils of 0.05:1 to 2.0:1.

In a further preferred embodiment, the catalytic cracking reaction zone may be operated at reaction conditions of: a reaction temperature of 550-700° C., a reaction time of 1-5 seconds, a weight ratio of catalysts to oils of 20:1 to 40:1, and a weight ratio of water to oils of 0.2:1 to 0.8:1.

In a preferred embodiment, the catalytic cracking catalysts comprise 1-50% by weight, preferably 5-45% by weight, and more preferably 10-40% by weight of zeolite; 5-99% by weight, preferably 10-80% by weight, more preferably 20-70% by weight of inorganic oxides; and 0-70% by weight, preferably 5-60% by weight, more preferably 10-50% by weight of clay, calculated on a dry basis, based on the dry weight of the catalysts.

In a further preferred embodiment, the zeolite comprises a mesoporous zeolite and optionally a macroporous zeolite, wherein the mesoporous zeolite is selected from a group consisting of ZSM series zeolites, ZRP zeolite and any combination thereof, and the macroporous zeolite is selected from a group consisting of rare earth Y-type zeolite, rare earth hydrogen Y-type zeolite, ultra stable Y-type zeolite, high silicon Y-type zeolite and any combination thereof. Further preferably, on a dry basis, the mesoporous zeolite is present in an amount of 10-100% by weight, preferably 50-90% by weight of the total weight of the zeolite.

In the present disclosure, the mesoporous zeolite and macroporous zeolite follow the conventional definitions in the field. That is, the mesoporous zeolite has an average pore size of about 0.5-0.6 nm, and the macroporous zeolite has an average pore size of about 0.7-1.0 nm. The examples of the macroporous zeolite may be one or more selected from a group consisting of rare earth Y (REY) zeolite, rare earth hydrogen Y (REHY) zeolite, ultra stable Y zeolite obtained by various methods, and high silicon Y zeolite. The mesoporous zeolite may be selected from a group consisting of zeolites with MFI structure, such as ZSM series zeolites, and/or ZRP zeolite. Optionally, the above-mentioned mesoporous zeolite may be further modified with non-metallic elements such as phosphorus and/or transition metal elements such as iron, cobalt and nickel. More detailed description on ZRP zeolite may be found in U.S. Pat. No. 5,232,675A. The ZSM series zeolites are preferably mixtures of one or more zeolites selected from a group consisting of ZSM-5, ZSM-11, ZSM-12, ZSM-23, ZSM-35, ZSM-38, ZSM-48 and other zeolites with similar structure. More detailed description on ZSM-5 may be found in U.S. Pat. No. 3,702,886A.

In accordance with the present disclosure, the inorganic oxide functions as a binder, and preferably is silica (SiO₂) and/or alumina (Al₂O₃). The clay functions as a matrix (i.e. a support), and preferably is kaolin and/or polyhydrated kaolin.

In a preferred embodiment, the method further comprises: feeding a reaction guiding agent into the fluidized catalytic cracking reactor through the inlet for additional materials of the fluidized catalytic cracking reactor, wherein the reaction guiding agent is selected from a group consisting of water and petroleum fractions, and the petroleum fractions are selected from a group consisting of naphtha fraction, middle distillate fraction, gas oil fraction, slurry oil, or a combination thereof.

In a further preferred embodiment, the reaction guiding agent and the feedstocks are fed in a weight ratio of 0.03-0.3:1, preferably 0.05-0.2.

In a preferred embodiment, the method further comprises: injecting fuel oils through an inlet for fuel oils provided at the lower part of the stripping device and/or in the connecting pipeline between the stripping device and the regenerator of the catalytic cracking system, so that the stripped spent catalysts and the fuel oil enter the regenerator for regeneration. Further preferably, the amount of the injected fuel oils and the amount of the fed feedstocks are in a weight ratio of 0.05-0.2:1.

In a preferred embodiment, the regenerated catalysts regenerated by the regenerator are at a temperature of 680-780° C.

The preferred embodiments of the catalytic cracking method in accordance with the present disclosure will be described in detail below with reference to the accompanying drawings. However, the scope of the present disclosure is not limited to those preferred embodiments.

As shown in FIG. 3, in a preferred embodiment, a catalyst lift medium is sent into the fluidized catalytic cracking reactor 1 from the bottom of the catalyst lift zone I through a pipeline 8, wherein the catalyst lift medium may be a dry gas, water vapor, or a mixture thereof. The hot regenerated catalysts are sent into the lower part of the catalyst lift zone I from a regenerated catalyst standpipe 13 and move upwards under the rising effect of the catalyst lift medium. The feedstocks such as preheated light feedstock oils and atomized vapor are injected into the upper part of the catalyst lift zone I and/or the bottom of the reaction zone II through a feed pipeline 9. They are subjected to mixing and contacting with the catalysts in the fluidized catalytic cracking reactor, and undergo catalytic cracking reaction when passing through the reaction zone II from bottom to top. The reaction product flows upwards and contacts with the reaction guiding agent injected through an inlet 10 for additional materials to terminate the reaction in time. The obtained catalysts deposited with coke and the reactor vapors are sent through the outlet zone III into a separation device 5, such as a cyclone separator, for separation of catalyst form the hydrocarbon vapors. The separated vapors are sent through a plenum chamber 6 and a vapor line 7 to leave the device and enter the subsequent separation system. The spent catalysts from separation are sent into the stripper. The stripped spent catalysts contact with the fuel oils injected through an inlet 11 for fuel oils to further deposit coke, and then are sent through a spent catalyst inclined tube 12 into a regenerator 2 to mix with air 14 at the bottom of the regenerator to burn coke. The regenerated catalysts are recycled through the regenerated catalyst standpipe 13 into the reactor 1. The flue gas of the regeneration is sent into the energy recovery system through a pipeline 15.

As shown in FIG. 4, in another preferred embodiment, a catalyst lift medium is sent into the fluidized catalytic cracking reactor from the bottom of the catalyst lift zone I through a pipeline 8, wherein the catalyst lift medium may be a dry gas, water vapor, or a mixture thereof. The hot regenerated catalysts from a regenerated catalyst standpipe 13, with or without being subjected to cooling, are sent into the lower part of the catalyst lift zone I and move upwards under the rising effect of the catalyst lift medium. The feedstocks such as preheated light feedstock oils and atomized vapor are injected through a feed pipeline 9 into the upstream of the catalyst lift zone I and/or the bottom end of the first diameter contracting reaction section 100, and subjected to mixing, contacting and reacting with the catalysts in the fluidized catalytic cracking reactor. The reaction streams are subjected to mixing with the recycled C4 introduced through a pipeline 16 at the bottom end of the second diameter contracting reaction section 100 ‘and further reacting. The reaction product flows upwards and contacts with the reaction guiding agent injected through a pipeline 10 to terminate the cracking reaction in time. The spent catalyst and the reactor vapors are sent through the outlet zone III into separation device 5, such as a cyclone, for separating catalysts from the hydrocarbon vapors. The separated reactor vapors are sent through a plenum chamber 6 and a vapor line 7 to leave the device and enter the subsequent separation system. The spent catalysts from the separation are sent into the stripper. The stripped spent catalysts contact with the fuel oil injected through an inlet 11 for fuel oils to further deposit coke, and then are sent through a spent catalyst inclined tube 12 into a regenerator 2 to mix with air 14 at the bottom of the regenerator to burn coke for regeneration. The regenerated catalysts are recycled through the regenerated catalyst standpipe 13 into the reactor 1. The flue gas of the regeneration is sent into the energy recovery system through a pipeline 15.

By using the fluidized catalytic cracking reactor, system and method in accordance with the present disclosure, it is possible to efficiently produce chemical raw materials such as ethylene and propylene from light petroleum hydrocarbons, assisting the transformation, development and extension of refineries from refining to chemical raw material production. It not only solves the problem of petrochemical raw material shortage, but also improves the economic benefits of refineries.

In certain preferred embodiments, provided in the present disclosure are the following technical solutions:

1. A fluidized catalytic cracking reactor, comprising sequentially from bottom to top:
optionally, a catalyst lift zone,
a catalytic cracking reaction zone, wherein the reaction zone comprises at least one diameter contracting reaction section, wherein the diameter contracting reaction section is a hollow column having a roughly circular cross-section and openings at the bottom and top ends, and its inner diameter is continuously reduced from its bottom end to its top end, and
an outlet zone,
wherein the optional catalyst lift zone is communicated with the bottom end of the reaction zone, wherein the top end of the reaction zone is communicated with the outlet zone, wherein at least one inlet for feedstocks is provided in the optional catalyst lift zone and/or at the bottom of the reaction zone;
wherein inner diameter of the cross-section at the bottom end of the reaction zone is greater than or equal to inner diameter of the cross-section of the optional catalyst lift zone, and inner diameter of the cross-section at the top end is equal to or greater than inner diameter of the cross-section of the optional catalyst lift zone and inner diameter of the cross-section of the outlet zone;
wherein one or more inlets for reaction guiding agents are provided at the upper part of the reaction zone, and the distance between the one or more inlets for reaction guiding agents and the outlet end of the reaction zone is 0 to 20% of the total height of the reaction zone.

2. The fluidized catalytic cracking reactor according to the item 1, where the ratio of inner diameter of the cross-section at the bottom end of the reaction zone to the total height of the reactor is 0.01:1 to 0.5:1; wherein the ratio of the total height of the reaction zone to the total height of the reactor is 0.15:1 to 0.8:1.

3. The fluidized catalytic cracking reactor according to the item 1, wherein the reaction zone comprises 1-3 diameter contracting reaction sections.

4. The fluidized catalytic cracking reactor according to the item 3, where the diameter contracting reaction sections are in the form of a hollow truncated cone with the longitudinal cross section in the shape of an isosceles trapezoid, wherein the ratio of inner diameter of the cross-section at the top end to the height of the diameter contracting reaction section is independently 0.005-0.3:1, wherein the ratio of inner diameter of the cross-section at the bottom end to the height of the diameter contracting reaction section is independently 0.015-0.25:1, wherein the ratio of inner diameter of the cross-section at the bottom end to inner diameter of the cross-section at the top end is independently greater than 1.2 and less than or equal to 10, wherein the ratio of the height of the diameter contracting reaction section to the total height of the reactor is independently 0.15:1 to 0.8:1.

5. The fluidized catalytic cracking reactor according to the item 4, where inner diameter of the cross-section at the top end of the diameter contracting reaction section is independently 0.2-5 meters.

6. The fluidized catalytic cracking reactor according to the item 1, where the ratio of inner diameter to the height of the catalyst lift zone is 0.02-0.4:1, wherein the ratio of the height of the catalyst lift zone to the total height of the reactor is 0.01:1 to 0.2:1.

7. The fluidized catalytic cracking reactor according to the item 6, where inner diameter of the catalyst lift zone is 0.2-5 meters.

8. The fluidized catalytic cracking reactor according to the item 6, where the catalyst lift zone is connected to the reaction zone through a first transition section, wherein the first transition section has a longitudinal cross section in the shape of an isosceles trapezoid which has an outward inclination angle on the side of the isosceles trapezoid a of 5-85°.

9. The fluidized catalytic cracking reactor according to the item 1, where the ratio of inner diameter of the cross-section to the height of the outlet zone is 0.01-0.3:1, wherein the ratio of the height of the outlet zone to the total height of the reactor is 0.05:1 to 0.5:1.

10. The fluidized catalytic cracking reactor according to the item 9, where inner diameter of the cross-section of the outlet zone is 0.2-5 meters.

11. A catalytic cracking system, comprising a catalytic cracking reaction device, a catalyst separation device, a stripping device, optionally a reaction product separation device, and a regenerator, wherein the catalytic cracking reaction device comprises one or more the fluidized catalytic cracking reactor accordance to anyone of items 1-10.

12. The catalytic cracking system according to the item 11, where at least one inlet for fuel oils is provided at the lower part of the stripping device and/or in the connecting pipeline between the stripping device and the regenerator.

13. The catalytic cracking system according to the item 12, where the at least one inlet for fuel oils is provided at the lower part of the stripping device, wherein the distance between the inlet for fuel oils and the bottom end of the stripping device is independently 0-30% of the height of the stripping device.

14. The catalytic cracking system according to the item 12 or 13, where the catalyst separation device comprises a disengager coaxially arranged with the fluidized catalytic cracking reactor or arranged with it in parallel at high and low positions.

15. A catalytic cracking method, comprising the step of: subjecting feedstocks and catalysts to contacting and reacting in the catalytic cracking system according to anyone of items 12-14.

16. The catalytic cracking method according to the item 15, where the feedstocks are selected from a group consisting of C4-C20 hydrocarbons.

17. The catalytic cracking method according to the item 16, where a reaction guiding agent is fed through an inlet for the reaction guiding agent of the fluidized catalytic cracking reactor into the fluidized catalytic cracking reactor, wherein the reaction guiding agent is selected from a group consisting of water and petroleum fraction oils, and the petroleum fraction oils are one or more selected from a group consisting of naphtha, middle distillate, gasoil and slurry oil.

18. The catalytic cracking method according to the item 17, where the reaction guiding agent and the feedstocks are fed in a weight ratio of 0.03-0.3:1.

19. The catalytic cracking method according to the item 16, where at least one inlet for fuel oils is provided at the lower part of the stripping device and/or in the connecting pipeline between the stripping device and the regenerator of the catalytic cracking system;

wherein the method further comprises injecting fuel oils through the inlet for fuel oils, so that the stripped spent catalysts and the fuel oils enter the regenerator for regeneration.

20. The catalytic cracking method according to the item 19, where the regenerated catalysts regenerated by the regenerator are at a temperature of 680-780° C.

### EXAMPLES

The following examples are intended to further illustrate the present disclosure and not to limit the invention in any way.

In the following examples and comparative examples, the feeds used were straight run naphtha, whose properties were listed in Table 1. The catalysts used were commercial catalytic cracking catalysts, available from the Catalyst Branch of China Petrochemical Corporation, with the product band of NCC.

Table 1 properties of the straight run naphtha used in the examples and comparative examples

| | |
|---|---|
| density(20° C.)/(g/cm³) | 0.7525 |
| Carbon content/wt % | 87.47 |
| Hydrogen content/wt % | 14.53 |
| Sulfur content/(mg/L) | 140 |
| Nitrogen content/(mg/L) | 1.2 |
| Distillation range/° C. | |
| 10 vol. % | 90.9 |
| 30 vol. % | 121.7 |
| 50 vol. % | 145.8 |
| 70 vol. % | 167.3 |
| 95 vol. % | 197.5 |
| Composition of | |
| hydrocarbons/wt % | |
| alkanes | 58.30 |
| olefins | 0 |
| cycloalkanes | 30.18 |
| aromatic hydrocarbons | 11.52 |

### Example 1

The feedstock oil shown in Table 1 and NCC catalyst were subjected to experiments on a pilot plant, which was in the configuration as shown in FIG. 3, wherein the reactor used had a structure as follows.

The reactor had a total height of 10 meters, and comprised a catalyst lift zone having a height of 2 meters and an inner diameter of 0.2 meters, a reaction zone having a height of 5 meters, an inner diameter of 0.2 meters at the top end and an inner diameter of 0.3 meters at the bottom end, and an outlet zone having a height of 3 meters and an inner diameter of 0.2 meters. An upper inlet for additional materials was provided at the position so that the distance between it and the outlet at the top end of the reaction zone was 0.5 meters.

In the stripper, an inlet for fuel oils was provided at the position so that the distance between it and the bottom end of the stripper was 10% of the height of the stripper.

During the operations, the amount of the reaction guiding agent injected and the amount of the feedstocks fed were in a ratio of 0.05:1 (by weight), and the amount of fuel oils injected was 6% of the amount of the feedstocks fed.

The conditions for the operations and the distribution of products were listed in Table 2. As can be seen from Table 2, the present example achieved a yield for ethylene of 25.53 wt %, a yield for propylene of 24.21 wt %, and yields for methane and coke of 10.07 wt % and 3.70 wt %, respectively.

### Example 2

The feedstock oil shown in Table 1 and NCC catalyst were subjected to experiments on a pilot plant, which was in the configuration as shown in FIG. 4, wherein the reactor used had a structure as follows.

The reactor had a total height of 10 meters, and comprised a catalyst lift zone having a height of 2 meters and an inner diameter of 0.2 meters, a reaction zone having a height of 5 meters and comprising a first segment of a hollow truncated cone having a height h₁ of 2.5 meters, an inner diameter of 0.2 meters at the top end and an inner diameter of 0.3 meters at the bottom end, and a second segment of a hollow truncated cone having a height h₂ of 2.45 meters, an inner diameter of 0.2 meters at the top end and an inner diameter of 0.3 meters at the bottom end, and an outlet zone having a height of 3 meters and an inner diameter of 0.2 meters. An upper inlet for additional materials was provided at the position so that the distance between it and the outlet at the top end of the second segment of the hollow truncated cone was 0.2 meters.

In the stripper, an inlet for fuel oils was provided at the position so that the distance between it and the bottom end of the stripper was 10% of the height of the stripper.

During the operations, the amount of the reaction guiding agent injected and the amount of the feedstocks fed were in a ratio of 0.05:1 (by weight), and the amount of fuel oils injected was 6% of the amount of the feedstocks fed.

The conditions for the operations and the distribution of products were listed in Table 2. As can be seen from Table 2, the present example achieved a yield for ethylene of 26.53 wt %, a yield for propylene of 26.13 wt %, and yields for methane and coke of 10.77 wt % and 3.86 wt %, respectively.

### Example 3

Experiments were made in accordance with Example 1 except that a bubble caps catalyst distributor was added at the bottom of the diameter contracting reaction section of the reaction zone II.

The conditions for the operations and the distribution of products were listed in Table 2. As can be seen from Table 2, the present example achieved a yield for ethylene of 25.76 wt %, a yield for propylene of 24.96 wt %, and yields for methane and coke of 9.16 wt % and 3.65 wt %, respectively.

### Comparative Example 1

The feedstock oil shown in Table 1 and NCC catalyst were subjected to experiments on a pilot plant, wherein the reactor used was a conventional riser reactor. The preheated feedstock oil was sent into the lower part of the riser reactor and contacted with the catalytic cracking catalyst to undergo catalytic cracking reaction. The stream obtained after the reaction was sent into the subsequent catalyst separation device and product separation device. The conditions for the operations and the distribution of products were listed in Table 2.

As can be seen from Table 2, this comparative example achieved a yield for ethylene of only 18.19 wt %, a yield for propylene of only 20.14 wt %, and yields for methane and coke of 12.95 wt % and 3.92 wt %, respectively.

### Comparative Example 2

The feedstock oil shown in Table 1 and NCC catalyst were subjected to experiments on a pilot plant, wherein the reactor used was a variable diameter riser reactor having reaction sections with increasing diameter (see the Chinese patent CN1152119C). The preheated feedstock oil was sent into the lower part of the riser reactor and contacted with the catalytic cracking catalyst to undergo catalytic cracking reaction. The stream obtained after the reaction was sent into the subsequent catalyst separation device and product separation device. The conditions for the operations and the distribution of products were listed in Table 2.

As can be seen from Table 2, this comparative example achieved a yield for ethylene of 18.96 wt %, a yield for propylene of only 22.15 wt %, and yields for methane and coke of 15.70 wt % and 5.01 wt %, respectively.

Table 2 comparisons of reaction results of Examples 1-2 and Comparative Example 1

| | Ex. 1 | Ex. 2 | Ex. 3 | CE. 1 | CE. 2 |
|---|---|---|---|---|---|
| Conditions in the | | | | | |
| reaction zone | | | | | |
| Temperature at the outlet | 675 | 675 | 675 | 675 | 675 |
| of the reaction zone, ° C. | | | | | |
| Reaction time, second | 2.0 | 2.1 | 2.0 | 2.5 | 3.1 |
| Weight ratio of | 0.3 | 0.3 | 0.3 | 0.3 | 0.3 |
| water to oils | | | | | |
| Weight ratio of | 30 | 30 | 30 | 30 | 30 |
| catalysts to oils | | | | | |
| Weight ratio of recycled | | 10 | | | |
| C4 to the feedstocks/% | | | | | |
| Distribution of | | | | | |
| products, wt % | | | | | |
| H2—C2 | 40.31 | 42.32 | 40.01 | 39.44 | 40.38 |
| Methane therein | 10.07 | 10.77 | 9.16 | 12.95 | 15.70 |
| Ethylene therein | 25.53 | 26.53 | 25.76 | 18.19 | 18.96 |
| C3—C4 | 38.15 | 34.79 | 38.5 | 36.49 | 37.14 |
| Propylene therein | 24.21 | 26.13 | 24.96 | 20.14 | 22.15 |
| gasoline | 15.55 | 16.73 | 15.63 | 17.23 | 15.58 |
| fuel oils | 2.29 | 2.30 | 2.21 | 2.92 | 1.89 |
| coke | 3.70 | 3.86 | 3.65 | 3.92 | 5.01 |
| total | 100 | 100 | 100 | 100 | 100 |

As can be seen from the above results of Examples and Comparative Examples, when the fluidized catalytic cracking reactor and system in accordance with the present disclosure were used in the catalytic cracking reaction of a hydrocarbon-containing feedstock, yields for ethylene and propylene were substantially enhanced whereas yields for methane and coke were reduced. In addition, in the fluidized catalytic cracking reactor and system in accordance with the present disclosure, providing a catalyst distributor at the bottom of the diameter contracting reaction section resulted in further improvements on the distribution of products, with reduced yields for methane and coke and increased yields for ethylene and propylene.

The preferred embodiments of the invention have been described in detail. However, the present invention is not limited to the specific details of the above embodiments. Various simple modifications may be made to the embodiments of the present invention within the technical scope of the present invention. Such simple modifications are within the protection scope of the present invention.

It should be also noted that, the various features described in the above embodiments may be combined in any suitable manner, as long as they do not conflict with each other. The present disclosure does not describe the possible combinations in detail in order to avoid unnecessary repetition.

In addition, any combination of the embodiments of the present invention is also possible as long as it does not depart from the spirit of the present invention, which should be considered as the disclosure of the present invention.

1. A fluidized catalytic cracking reactor, comprising sequentially from bottom to top: a catalytic cracking reaction zone and an outlet zone, wherein the top end of the reaction zone is communicated with the bottom end of the outlet zone, wherein the reaction zone comprises at least one, preferably 1-3, diameter contracting reaction section which has inner diameter continuously reduced from its bottom end to its top end, and has inner diameter at the top end which is greater than or equal to inner diameter of the outlet zone, and wherein the ratio of the total height of the at least one diameter contracting reaction section to the total height of the reactor is 0.15:1 to 0.8:1, preferably 0.2:1 to 0.75:1;
preferably, the ratio of the total height of the at least one diameter contracting reaction section to the total height of the reaction zone is 0.7:1 to 0.95:1, preferably 0.75:1 to 0.90:1, and/or
the ratio of inner diameter at the bottom end to inner diameter at the top end of the at least one diameter contracting reaction section is independently greater than 1.2:1 to 10:1, preferably 1.5:1 to 5:1.

2. The fluidized catalytic cracking reactor of claim 1, wherein a catalyst distributor is provided at the bottom of the at least one diameter contracting reaction section,
preferably, when multiple diameter contracting reaction sections are provided, the catalyst distributor is provided at the bottom of the most upstream diameter contracting reaction section along the streams moving direction; further preferably, the catalyst distributor is provided at the bottom of each diameter contracting reaction section.

3. The fluidized catalytic cracking reactor of claim 1, further comprising a catalyst lift zone, wherein the top end of the catalyst lift zone is communicated with the bottom end of the reaction zone, wherein at least one, preferably 1-3, inlet for catalytic cracking catalysts is provided in the catalyst lift zone and/or the reaction zone, and at least one, preferably 1-3, inlet for feedstock is provided in the catalyst lift zone and/or the reaction zone, and wherein inner diameter at the bottom end of the at least one diameter contracting reaction section is greater than inner diameter of the catalyst lift zone,
preferably, inner diameter at the top end of the at least one diameter contracting reaction section is greater than or equal to inner diameter of the catalyst lift zone,
further preferably, when n diameter contracting reaction sections are provided, where n≥2, an additional inlet for catalysts and/or an additional inlet for feedstock are provided at the bottom of at least one, preferably each one, of the second to n diameter contracting reaction sections along the streams moving direction.

4. The fluidized catalytic cracking reactor of claim 1, wherein at least one, preferably 1-3, inlet for additional materials is provided at the upper part of the reaction zone, wherein the distance between the at least one inlet for additional materials and the top end of the reaction zone is independently 0 to 20%, preferably 0 to 15% of the total height of the reaction zone.

5. The fluidized catalytic cracking reactor of claim 1, wherein the at least one diameter contracting reaction section is in the form of a hollow truncated cone with the longitudinal cross section in the shape of an isosceles trapezoid; the ratio of inner diameter at the top end to the height of the at least one diameter contracting reaction section is independently 0.005-0.3:1, preferably 0.02-0.2:1; the ratio of inner diameter at the bottom end to the height of the at least one diameter contracting reaction section is independently 0.015-0.25:1, preferably 0.05-0.2:1; the ratio of inner diameter at the bottom end to inner diameter at the top end of the at least one diameter contracting reaction section is independently greater than 1.2:1 to 10:1, preferably 1.5:1 to 5:1;
preferably, the ratio of the height of the at least one diameter contracting reaction section to the total height of the reactor is independently 0.15:1 to 0.8:1, for example, 0.2:1 to 0.75:1;
further preferably, the ratio of inner diameter at the bottom end of the at least one diameter contracting reaction section to the total height of the reactor is independently 0.01:1 to 0.5:1, preferably, 0.05:1 to 0.2:1;
more further preferably, inner diameter at the top end of the at least one diameter contracting reaction section is independently 0.2-5 meters, preferably 0.4-3 meters.

6. The fluidized catalytic cracking reactor of claim 3, wherein the ratio of inner diameter to the height of the catalyst lift zone is 0.02-0.4:1, preferably 0.05-0.2; the ratio of the height of the catalyst lift zone to the total height of the reactor is 0.01-0.2:1, preferably 0.05-0.15:1;
preferably, inner diameter of the catalyst lift zone is 0.2-5 meters, preferably 0.4-3 meters.

7. The fluidized catalytic cracking reactor of claim 3, wherein the catalyst lift zone is connected to the reaction zone through a first transition section, wherein the first transition section is in the form of an inverted hollow truncated cone which has a longitudinal cross section in the shape of an isosceles trapezoid with an outward inclination angle on the side of the isosceles trapezoid a of 5-85°, preferably 15-75°.

8. The fluidized catalytic cracking reactor of claim 1, wherein the ratio of inner diameter to the height of the outlet zone is 0.01-0.3:1, the ratio of the height of the outlet zone to the total height of the reactor is 0.05:1 to 0.5:1, preferably 0.1:1 to 0.35:1,
preferably, inner diameter of the outlet zone is 0.2-5 meters, preferably 0.4-3 meters.

9. A catalytic cracking system, comprising a catalytic cracking reaction device, a catalyst separation device, a stripping device, optionally a reaction product separation device, and a regenerator, wherein the catalytic cracking reaction device comprises at least one, preferably 1-3, the fluidized catalytic cracking reactor of claim 1,
preferably, at least one, preferably 1-3, inlet for fuel oils is provided at the lower part of the stripping device and/or in the connecting pipeline between the stripping device and the regenerator.

10. The catalytic cracking system of claim 9, wherein the at least one, preferably 1-3, inlet for fuel oils is provided at the lower part of the stripping device, and the distance between the at least one inlet for fuel oils and the bottom end of the stripping device is independently 0-30%, preferably 5-25% of the height of the stripping device.

11. The catalytic cracking system of claim 9, wherein the catalyst separation device comprises a disengager coaxially arranged with the fluidized catalytic cracking reactor or arranged with it in parallel at high and low positions.

12. A catalytic cracking method, comprising the step of: subjecting a hydrocarbon containing feedstock and a catalytic cracking catalyst to contacting and reacting in the fluidized catalytic cracking reactor of claim 1,
preferably, the feedstock is selected from a group consisting of C4-C20 hydrocarbons.

13. The catalytic cracking method of claim 12, further comprises: feeding a reaction guiding agent through the inlet for additional materials of the fluidized catalytic cracking reactor into the fluidized catalytic cracking reactor, wherein the reaction guiding agent is selected from a group consisting of water and petroleum fractions, and the petroleum fraction oils are selected from a group consisting of naphtha, middle distillate, gasoil, slurry oil, or a combination thereof,
preferably, the reaction guiding agent and feedstock are fed in a weight ratio of 0.03-0.3:1, preferably 0.05-0.2:1.

14. The catalytic cracking method of claim 12, further comprising: injecting fuel oils through an inlet for fuel oils which is provided at the lower part of the stripping device and/or in the connecting pipeline between the stripping device and the regenerator of the catalytic cracking system, so that the stripped spent catalysts and the fuel oils enter the regenerator for regeneration,
preferably, the regenerated catalysts are at a temperature of 680-780° C.
